(19) United States
(12) Patent Application Publication
(10) Pub. No.: US 2003/0233276 A1
(43) Pub. Date: Dec. 18, 2003

(54) System and method of using portable electronic devices for electronic coupon and voucher redemption

(76) Inventors: Mark Pearlman, New York, NY (US); Robert M. Pelovitz, Nashua, NH (US); Ralph Baer, Manchester, NH (US)

Correspondence Address: R. Neil Sudol, COLEMAN SUDOL SAPONE, P.C., 714 Colorado Avenue, Bridgeport, CT, 06605-1601, US

(21) Appl. No.: 10/262,592

(22) Filed: Sep. 30, 2002

Related U.S. Application Data
(60) Provisional application No. 60/390,041, filed on Jun. 18, 2002.

(51) Int. Cl. G06F 17/60

(52) U.S. Cl. 705/14

(57) ABSTRACT

In a method for carrying out the distribution and administration of promotional offers, electronic coupons are loaded into portable electronic devices having displays. The users present portions of the electronic coupon data on the displays at retail locations where the displayed information is optically scanned into registers or retail computers. A coupon distribution and administration service may operate a server on the global computer network for purposes of publishing promotional offers and tracking the downloading, usage and redemption of the promotional offers.

### BACKGROUND OF THE INVENTION

The present invention relates generally to a method for information transfer and more specifically to such a method for enabling or carrying out promotional offers in retail transactions.

Currently, promotions in retail transactions are carried out using paper. For example, grocery store coupons may be clipped from weekly circulars. In consumer electronics and computer stores, rebates are provided through forms, which must be filled out and then sent to the manufacturer with other related documentation, such as a copy of the register receipt.

In marketing to consumers, the use of any opportunities to promote sales will benefit both the companies offering products and the consumers who buy them. Companies are constantly searching for marketing strategies that will distinguish them from their competitors, who are of course vying for the same consumer base.

### OBJECTS OF THE INVENTION

It is an object of the present invention to provide the means for a strategy that will permit companies to reach their customers using an entirely new channel, thus increasing the likelihood that consumers will select their goods or services over those offered by others.

It is a more specific object of the present invention to create a new channel of distribution for the use of coupons and vouchers, which permits manufacturers and retailers to either extend their existing campaigns into the electronic medium or to create entirely new offerings.

These and other objects of the present invention will be apparent from the drawings and descriptions herein. Although each embodiment disclosed herein is believed to attain at least one object of the invention, there is not necessarily any one embodiment that achieves all objects of the invention.

### SUMMARY OF THE INVENTION

The present invention recognizes that the large installed base of hand-held or portable electronic devices opens up opportunities for marketing and sales, which until recently were not generally feasible. Portable electronic devices are readily available to consumers to increase their productivity when away from the home or office. Personal digital assistants (PDAs) are one example of such devices. PDAs are basically miniaturized portable computers, containing microprocessors, input buttons, an LCD display, a touch screen and interface circuitry permitting the device to communicate with computers and other PDAs, as well as link to the global computer network known as the Internet. A variety of methods support this communication. Amongst these are hardwired connection (through a cable), IR (infrared) transfer (also referred to as ‘beaming’), and several different protocols relying upon RF (radio frequency) transmission of information.

The present invention introduces the concept of using portable electronic devices, such as PDAs, mobile phones, portable video game players and beepers to present promotional offers (i.e., coupons, prize vouchers (“vouchers”), gift certificates) in exchange for discounts, rebates, refunds, or other special incentives on goods and services at the point of sale (POS). The vouchers could be downloaded for consideration of playing games or entering and winning contests.

A method for information transfer comprises, in accordance with the present invention, loading data into a portable electronic device having a display, displaying at least a portion of the data in a predetermined format on the display, and presenting the display to a scanner to enable a scanning of the portion of the data on the display. The predetermined format may include a bar code, either one-dimensional or two-dimensional.

The display showing the data may be presented to a scanner at a retail outlet or point or sale. In that case, at least the displayed portion of the data encodes a promotional offer pertinent to a predetermined good or service purchased at the retail outlet.

The portable electronic device is preferably a mobile telephone, a cellular telephone, a personal digital assistant, a pager, an electronic gaming device, or a portable television. Other kinds of portable electronic devices developed in the future may also be used in carrying out the present invention.

In accordance with further features of the present invention, the loading of the data into the portable electronic device includes transmitting the data to the portable electronic device either through a wired connection or wirelessly, for instance, via an IR or RF communications link. The source of the data may be at a retail establishment or a broadcasting station, such as a telephone repeating station.

The data may be downloaded into the portable electronic device from a World Wide Web site. The portable electronic device may be in direct contact with the World Wide Web via a hard-wired or wireless communications link. Alternatively, the data may arrive indirectly via a host computer in turn connected to the Internet.

It is contemplated that the data is loaded into the portable electronic device in return for or in response to the supplying of personal information (of the consumer) to a provider of the data. The provider of the data (e.g., a promotional offer such as an electronic coupon or voucher or gift certificate) generally desires the consumer information for market research purposes.

In accordance with further features of the present invention, at least a part of the data is automatically deleted from the portable electronic device after the scanning of the portion of the data, whereas software is loaded into the portable electronic device prior to the loading of the data. The portable electronic device is operated pursuant to the loaded software to receive the data and display the relevant portion of the data on the display of the portable electronic device, as well as to delete the data once it has been used (displayed and scanned). The software may also function to delete the data by a predetermined expiration date, regardless of whether the data has been used.

The method of the present invention more particularly contemplates that the scanned data is transmitted to an electronic accounting device, for instance, to facilitate completion of a price adjustment (discount, rebate, refund, free gift, etc.) in a retail purchase of consumer goods or services.

A transactional method in accordance with the present invention comprises (a) receiving an electronic coupon comprising information in a predetermined encoded format, (b) storing the electronic coupon in a portable electronic device, (c) transporting the portable electronic device to a retail location, and (d) communicating at least a pertinent portion of the information from the portable electronic device at the retail location to permit execution of a promotional transaction at the retail location.

The communicating of the information may include transferring the pertinent portion of the information to an electronic accounting device at the retail location. This information transfer may include displaying the pertinent portion of the information on a display of the portable electronic device at the retail location, thereby enabling a scanning of the display to transfer the portion of the information to the electronic accounting device. Alternatively or additionally, the information transfer may include transmitting the pertinent portion of the information over a communications link to the electronic accounting device. This communications link exemplarily takes the form of an IR or RF link.

The receiving of the electronic coupon may include downloading the electronic coupon from a World Wide Web site. Where the Web site is operated by a coupon provider, the method may additionally comprise supplying personal information over the Internet to the coupon provider prior to the receiving of the electronic coupon. In an alternative mode of carrying out the invention, the electronic coupon is downloaded from a source at the retail location. This downloading may be implemented via a wireless (IR, RF, ultrasonic) link or via a hard-wired connection, as where the portable electronic device is plugged into a kiosk or terminal at the retail location.

At least a portion of the electronic coupon may be deleted from the portable electronic device after the communicating of the portion of the information at the retail location.

Where a product (consumer goods and/or services) is purchased at the retail location, the electronic coupon is directed to the purchase of the product, while the promotional transaction may include an adjustment in a purchase price of the product.

A method for facilitating promotional offers on the sale of products comprises, in accordance with the present invention, receiving personal information from consumers, and in response to the receipt of the personal information, automatically transmitting electronic coupons or vouchers to respective consumers. The receiving of the personal information preferably includes receiving incoming signals via a global computer network (e.g., the Internet), while the transmitting of the electronic coupons or vouchers includes transmitting outgoing signals via the Internet.

In accordance with another feature of the present invention, a database of electronic coupon and voucher data is maintained. At least a portion of that stored data is communicated to prospective consumers via a World Wide Web site. In addition, it is contemplated that a database of consumer preference information will be maintained to facilitate the keying or tailoring of the promotional offers to the desires and interests of the consumers. The stored consumer preference information may be additionally organized and analyzed for statistical evaluation.

As mentioned hereinabove, the electronic coupons or vouchers may include information that can be encoded in bar codes.

Prior to the transmitting of the electronic coupons or vouchers to the respective consumers, software is transmitted to the respective consumers for enabling a communication of at least selected portions of the coupons or vouchers. The software may specifically include means for enabling display of a bar code on a display of a portable electronic device.

In accordance with a further feature of the present invention, the method for facilitating promotional offers on the sale of consumer products further comprises receiving a query regarding a pending promotional transaction, checking the personal information to verify validity of the pending promotional transaction, and transmitting a signal authorizing completion of the pending promotional transaction. These steps are preferably performed automatically by software installed in connection with a World Wide Web site or via a dedicated server/connection.

In accordance with a further feature of the present invention, the electronic coupons or vouchers are generated in response to requests from corporate sponsors.

Where coupon transmission requests are received from consumers, the transmitting of the electronic coupons or vouchers are carried out in response to the coupon transmission requests. The method for facilitating promotional offers on the sale of consumer goods and/or services then further comprises automatically tracking coupon transmission requests.

Where a termination request is received from a corporate sponsor, at least one of the electronic coupons or vouchers is automatically terminated pursuant to the request.

A transactional method in accordance with another feature of the present invention comprises scanning a display of a portable electronic device to collect information shown on the display, entering the collected information to another electronic device, and operating this other electronic device to extract the collected information and incorporate the extracted information in a transactional process. The scanning of the display preferably includes operating a scanner instrument, while the entering of the collected information includes automatically transmitting the collected information from the scanner instrument to the other electronic device. The scanning of the display may include operating a laser, imaging or optical scanner.

Where the collected information pertains to a promotional offer on a product for sale in a retail establishment, the transactional process being a sale of the product, the incorporation of the extracted information includes accounting for a price adjustment in the sale of the product.

In an alternative process for carrying out the invention, the scanning of the display is done visually while the entering of the collected information is done manually.

In accordance with another feature of the present invention, the method further comprises generating a validation request signal in response to the extracted information, transmitting the validation request signal to a remote location, receiving an authorization signal from the remote locations in response to the validation request signal, and completing the transactional process upon receipt of the authorization signal.

The present invention contemplates using the display of a portable electronic device or a small attachment, to present electronic coupons or vouchers to cashiers at the point of sale. One method is to place on the screen of the display an image of the UPC barcode that would commonly be printed on a coupon. When placed in the path of either a laser or imaging scanner, the electronic coupon or voucher is accepted much in the same way as a conventional coupon. The display can also be used to present newer 2-D barcode formats, if desired. Alternatively, other forms of communication such as IR or RF can be used to present the electronic coupon or voucher information.

As discussed above, the electronic coupons or vouchers are electronically generated, transmitted, and received or downloaded, by any available communication link, from the World Wide Web or some other data server, where said coupons are in the form of digital or analog data and involve no printing processes. The electronic coupons or vouchers are redeemed for goods and/or services advertised on the World Wide Web or through some other channel of communication. Vouchers or electronic coupons may also be redeemable for cash, credits or rebates if so desired.

As additionally discussed above, the electronic coupons or vouchers are electronically generated, transmitted, and received or downloaded, directly from a wireless link, such as an IR or RF link, where said electronic coupons and vouchers are in the form of digital or analog data and again involve no printing processes. Some examples of such an implementation are (1) receiving electronic coupons into a PDA or mobile phone, either widely broadcast or sent to a specific, targeted consumer(s); (2) receiving electronic coupons while shopping in a store (i.e., electronic ‘blue light’ specials), which could even expire within a specific time limit; (3) receiving electronic coupons via IR & RF links in a store from a ‘walk-up’ terminal for downloading coupons or possibly entering sweepstakes. One would need to be located within a specific radius of the terminal in order to partake of its offerings. Such a system may even include instant winners. Once again, vouchers or electronic coupons can also be redeemable for cash, credits or rebates if so desired.

The present invention permits the communication of gift certificates to portable electronic devices, for redemption at the point of sale. Such gift certificates can be transmitted over any known communication link between portable electronic devices, from the Internet or other data server, or from the point of sale to the portable electronic device. Once transmitted, the gift certificate may be redeemed either using a barcode scanner, by manually entering a control code through the keypad of their register, or by any other available data link supported at the point of sale.

Pursuant to an additional feature of the present invention, portable electronic devices are enabled, if so desired by a goods manufacturer or service provider and if feasible at the point of sale, to transfer information representing the buyers and their preferences and buying habits. This may be performed in conjunction with the presentation of an electronic coupon, voucher or gift certificate (promotional offer).

The electronic coupons or vouchers can either be scanned from the LCD display of the portable electronic device, or an attachment if required or desired. Alternatively, other forms of communication such as IR or RF may be used to present the electronic coupon information. Additionally, information representing the buyer and their preferences and buying habits may be collected as well.

The present invention enables a whole new contesting and gaming approach that brings the consumer to the retail point of sale to win a prize. The electronic coupon or voucher loaded into a portable electronic device may be for a free gift at the retail point of sale, or a gift tendered with a purchase of a predefined product.

The present invention may also be used to receive and redeem gift certificates. In this scenario, gift certificates may be sent or transferred electronically, for example from the Internet, between portable electronic devices, or possibly from a business to an individual's portable electronic device. The gift certificate may then be redeemed by using the portable electronic device at the point of sale, as described herein. This same technique may be applied to refunds as well.

The present invention achieves its objectives without requiring the retail customer (who is in possession of the portable electronic device) to acquire any new piece of electronic hardware. It is also a basic concept of the present invention to deliver such software as may be needed to the customer free of charge, possibly via well-established data downloading means, such as the supplier's Web site in any manner of data-downloading from the Web as is, or shall become well-known in the art. In certain circumstances however, when for example the display of a specific portable electronic device does not provide ample reflective properties for barcodes to be readable by a scanner, it may be either advantageous or necessary to develop, and either sell or give away, a small and inexpensive attachment containing a scanner-readable display. Alternatively, other information displayed alpha-numerically on the customer's portable electronic device (PDA, cell phone, etc.) can be directly entered by a sales clerk using the keypad of the checkout register so that such customers may still receive the benefits provided by said Promotional Offer(s).

Security is an issue that is addressed as an additional objective of the present invention. The electronic couponing methods must ensure that an electronic coupon may only be used once by an individual. Also, the method must make counterfeiting difficult. Various available methods may be used to mitigate security issues. For example, encryption and decryption techniques may be applied to the electronic coupon and software application data. The application itself can be programmed to automatically erase electronic coupon data once displayed, after a certain amount of time has elapsed and may lock out other applications from reading display memory while the coupon is displayed. Other validating information can also be included on the electronic coupon display, and can even be calculated to change based upon the date and time of use. Purchaser IDs may also be used as further verification. Additionally, certain rebates may require that the consumer hot-sync to the vendor site for validation, after which a rebate check is mailed out. In this way, the product vendor would have immediate knowledge of the individual taking advantage of the rebate. This could be generally applied to all electronic coupons if desired and could possibly transpire over a wireless link as well.

Generally speaking, it is a particular objective of the present invention to make use of currently available and future models of portable electronic devices or transaction devices such as Personal Digital Assistants (PDA's) sold under trade names such as Palm, Handspring, Compaq, HP, Sony, RIM, and others rather than developing a separate unit to perform the functions described.

The enabling innovation of the present invention resides in the fact that the inventors have discovered that in most cases, it is possible to “read” a barcode displayed on the screen of said portable electronic devices with existing bar code readers of the types currently used in retail establishments. This includes bar code scanner/readers of the in-counter type as well as various types of hand held bar code scanner/readers.

In the case of black-and-white LCD displays used in lower-priced PDA's, the near-white background of their LCD's returns sufficiently more light, when illuminated by red laser beam or imager's illumination strip, than the black areas of said LCD-displayed bar code. This reflective difference provides an adequate signal to noise ratio, for the reader to accurately recognize the code. In the alternative case of higher-priced PDA's equipped with one of various forms of color displays, including passive and active matrix LCD types, proper pattern recognition has also been found to be achievable by the inventors of the present invention. This is due to the fact that white or near white light emitted by said color displays illuminates the laser reader sensor device or imaging surface differentially when it is passing over a black bar as compared to the return of light when passing over a white space or bar. Thus, while the optical mechanism in detecting and correctly reading said bar codes may vary widely between differing types of LCD displays, accurate “reads” of the data contained in standard forms of bar codes displayed on said screens is entirely attainable. As a consequence, if a means is provided to introduce the data required to display a particular bar code on the LCD display of a PDA, its owner needs to acquire no further apparatus.

A major advantage and feature of the present invention is that is makes use of virtually all of the presently installed systems supporting paper couponing without requiring any major changes to these systems, and is flexible for future anticipated technological advances. Thus, couponing offers originating on the World Wide Web, or from other sources, will likely require new software only at the URL level. Once the couponing data is retrieved into the consumer's portable electronic device, taking the device to a store for redemption is identical to the action required for paper coupons.

From a business perspective, the present invention provides product vendors with an entirely new channel to reach potential customers and to effect their buying decisions.

### BRIEF DESCRIPTION OF THE DRAWINGS

FIG. 1 is a schematic elevational view of a portable electronic device in the form of a personal digital assistant, showing a barcode on a display of the device, pursuant to a method in accordance with the present invention.

FIG. 2 is a schematic elevational view of a portable electronic device in the form of a cellular telephone, showing a barcode on a display of the device, pursuant to a method in accordance with the present invention.

FIG. 3 is a schematic elevational view of the portable electronic device of FIG. 1 and of a handheld retail scanner scanning the barcode on the display of the device, pursuant to a method in accordance with the present invention.

FIG. 4 is a block diagram of a coupon distribution system or network in accordance with the present invention.

FIG. 5 is a block diagram of a coupon distribution and administration server depicted in FIG. 4.

FIG. 6 is a block diagram of a customer access module shown in FIG. 5.

### DEFINITIONS

The word “product” is used herein to refer to any kind of consumer goods or services that may be the subject of a promotional offer.

The term “promotional offer” as used herein refers generally to any form of reward or incentive proffered to a consumer in return for the consumer's purchase of a designated kind of product. The reward or incentive may particularly take the form of a discount, rebate or refund. Alternatively, a promotional offer may comprise a gift such as a product. A promotional offer may be the opportunity to take part in a contest. Promotional offers as contemplated by the present invention are executed at the point of sale. Promotional offers may be implemented as coupons, prize vouchers (“vouchers”), or gift certificates in exchange for discounts, rebates, refunds, or other special incentives on goods and services at the point of sale.

The term “electronic coupon” or electronic voucher” is used herein to designate a packet or collection of data formatted for the transmission and communication of information at least identifying a product and a promotional offer pertaining to such product. An electronic coupon or voucher may include additional information such as an identification of a consumer authorized to present the coupon or voucher for redemption or a price adjustment as to the identified product. An electronic coupon may also incorporate an expiration date (and time). Software in a portable electronic device that receives and stores the electronic coupon for presentation, for instance, at a retail location, may be designed to recognize the expiration data and to automatically delete or terminate the electronic coupon or voucher pursuant to the expiration data. An electronic coupon or voucher may function as a gift certificate, obtained by an individual or corporate entity and given to a consumer for obtaining a discount, rebate, free gift, or other promotional consideration.

A “portable electronic device” as that term is used herein designates any kind of apparatus that can receive, store, recognize, identify, operate on, and display information encoded in electronic or electrical signals. Generally, such devices include a microprocessor programmed or programmable to operate on electrically encoded data. Examples of portable electronic devices include mobile telephones, cellular telephones, personal digital assistants, laptop and notebook computers, pagers, electronic gaming devices, and portable television sets.

The term “electronic accounting device” is used herein to denote any kind of electronic cash register, calculator, dedicated or specially programmed computer, or other electronic device constructed and designed to perform mathematical operations on monetary amounts and to track purchase and sales transactions.

The word “accounting” is used herein to denote any sort of mathematical computation or database entry that carries out or implements a price adjustment in a commercial or retail transaction.

The term “retail location” is used herein to denote the point of sale (POS) of a consumer product.

The term “scanner” is used herein to designate any kind of optical device capable of reading symbols presented on an optical display such as an LCD display. Scanners include laser scanners, imaging scanners, light pens, and other optical scanners typically used at retail outlets to read bar codes on products or on paper coupons.

### DETAILED DESCRIPTION OF THE PREFERRED EMBODIMENTS OF THE INVENTION

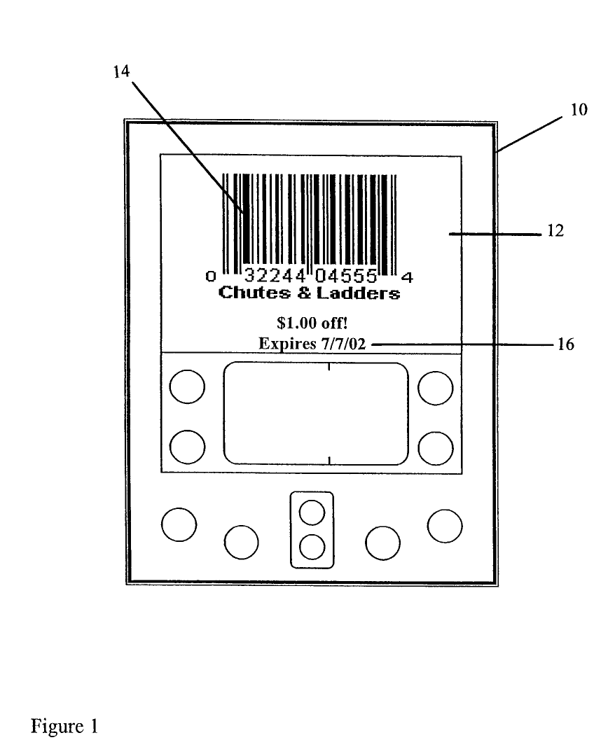

As illustrated in FIG. 1, a portable electronic device 10 in the form of a personal digital assistant (PDA) has a display 12 on which selected portions of a promotional offer are displayed. The displayed portions of the promotional offer include a machine readable code, particularly a bar code 14, as well as alphanumeric symbols or textual material 16. The text conveys information of interest to a consumer who brings the PDA 10 with him or her to a retail location. Such textual information may include a dollar amount representing the value of the promotional offer, as well as an expiration date. Other information may identify the type of product to which the promotional offer pertains and a retail store name or address.

Bar code 14 encodes the usual information that is contained in bar codes on paper coupons, such as manufacturer, product, offer value, etc. Where the promotional offer is a free gift or item of merchandise, that information may also be encoded in the bar code 14.

As discussed hereinafter, bar code 14 is a portion of an electronic coupon that is stored temporarily in a memory of PDA 10. Prior to the generation of bar code 14 on display 12 and the presentation of the displayed bar code at a retail location or point of sale, the electronic coupon is loaded into the memory of PDA 10 by any of several methods discussed below. The information encoded in bar code 14 may be transmitted to PDA 10 and stored in the internal memory thereof in any suitable format. PDA 10 is previously provided with software that selects and converts the bar code information into the bar code format for presentation via display 12.

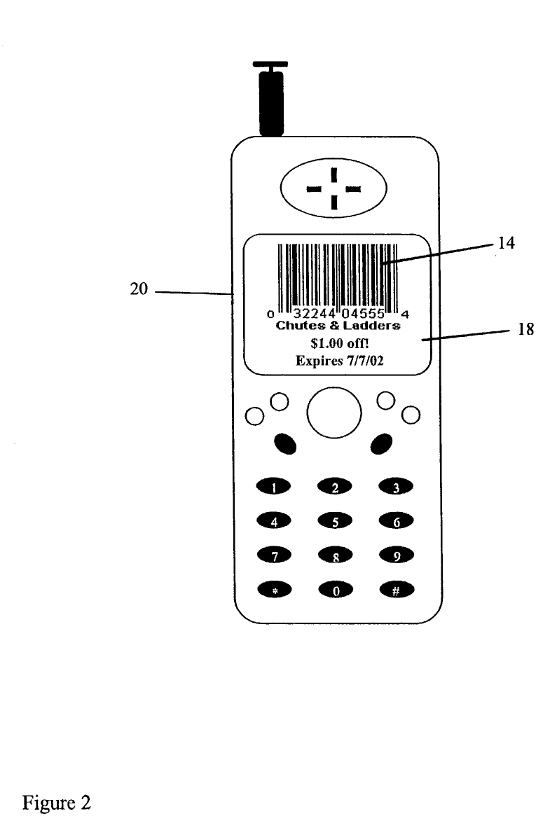

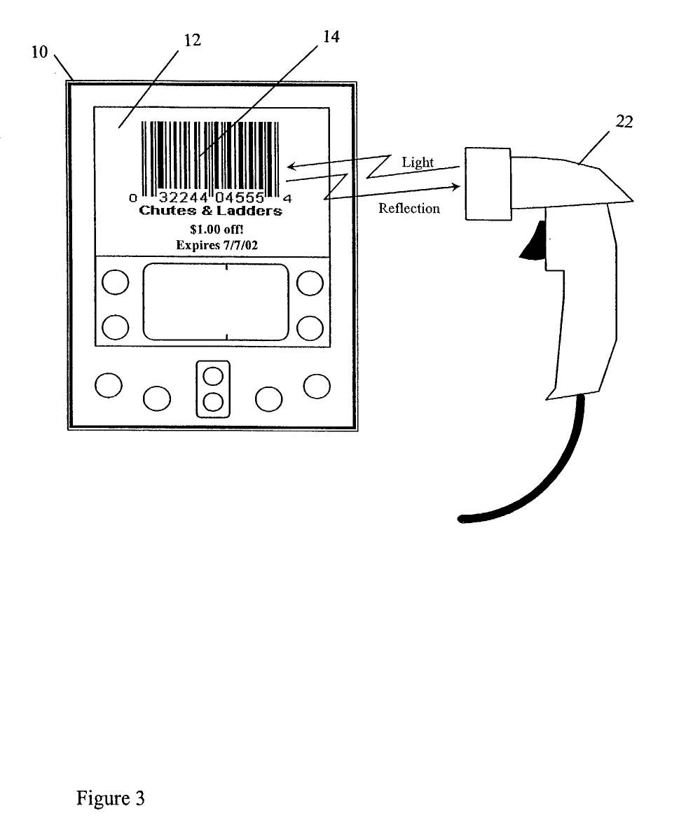

FIG. 2 depicts the same bar code 14 and textual material 16 on a display 18 of a cellular or mobile telephone 20. As illustrated in FIG. 3, the displayed bar code 14 is read at a retail location by a laser scanner or other optical bar code reader 22. The scanned bar code information is used by a retailer accounting device, such as a cash register, to confirm and implement the promotional offer for the consumer presenting the bar code 14 on display 12 or 18.

In one preferred embodiment of a promotional offer implementation system, a commercial entity advertising products on the World Wide Web is the issuer of price reductions in the form of one or more promotional offers. The acquisition of the promotional offers may be initiated by a potential consumer, who has accessed a web site and selected a ‘download’ button, causing electronic coupon data required for the future display of barcode 14 to be stored in their personal computer or directly in PDA 10 or cellular phone 20 or other portable electronic device. In the former scenario, the electronic coupons or vouchers are later downloaded into PDA 10 via a docking device or a wireless communications means, as is commonly done in the current art.

Once an electronic coupon is stored in PDA 10, telephone 20 or other portable electronic 10 device, the user/consumer buying a product in a retail store may redeem the web-delivered coupon (accept the promotional offer) by simply causing the displayed bar code 14 on his or her PDA 10, etc., to be accessed and read by one of the store's in-counter or hand-held bar code readers 22.

In a second preferred embodiment of a promotional offer implementation system, the viewer/consumer may access a Web site via a television set equipped with a set-top box capable of accessing URL's on the World Wide Web. If the set-top box has the capability to interface with the customer's PDA 10, downloading may be effected in the manner described in connection with above-described embodiment. If that capability does not exist, data downloading may be done in accordance with, for example, the teachings of U.S. Pat. No. 3,993,861 (Digital Video Modem), or data may be nested in audio as a spread spectrum signal or via other techniques known in the art.

The techniques described herein can be achieved with most if not all portable electronic devices including PDAs, mobile phones, laptops, portable videogame devices etc. Where a particular portable electronic device is not equipped by the manufacturer with a scannable display, an attachment device (not illustrated) may be provided in the form of a small module that contains a small scannable display, such as an LCD strip and drive electronics. This device is plugged into the connector of a portable electronic device, such as a PDA or PDA/cell phone, thus forming an electrical connection to the internal circuitry of the handheld device. This LCD is then used to display the bar code instead of the main display.

It is to be noted that an electronic coupon or voucher embodying a promotional offer(s) may be transmitted over a variety of new or wireless existing communication channels (such as IR, RF, Microwave, Satellite, etc.) and using a wide variety of data transfer protocols. Electronic coupons or vouchers may additionally or alternatively be transmitted over hard-wired connections, for example, where a kiosk in a retail store includes sockets or plugs for forming connections with various portable electronic devices.

It is to be noted further that display screens and display techniques may vary depending upon the specific application.

Set forth below are seven receipt/redemption methods that are anticipated to be included within the scope of the electronic coupon method of the present invention. The discussion below sets forth a scheme for each to define the coupon's or voucher's journey, tracking, etc.

Electronic coupons or vouchers are loaded into a portable electronic device by one or more of the following methods:

Internet download from a central coupon distribution and administration site

Internet download from manufacturer's site

Internet download from store's web site

Received from store at register

Broadcast from in-store terminal (e.g., blue light specials, sweepstakes, etc.)

Broadcast over the air (i.e., wireless phone)

Broadcast over the air (i.e., network—Bluetooth™)

Internet Download from Central Coupon Distribution and Administration Site

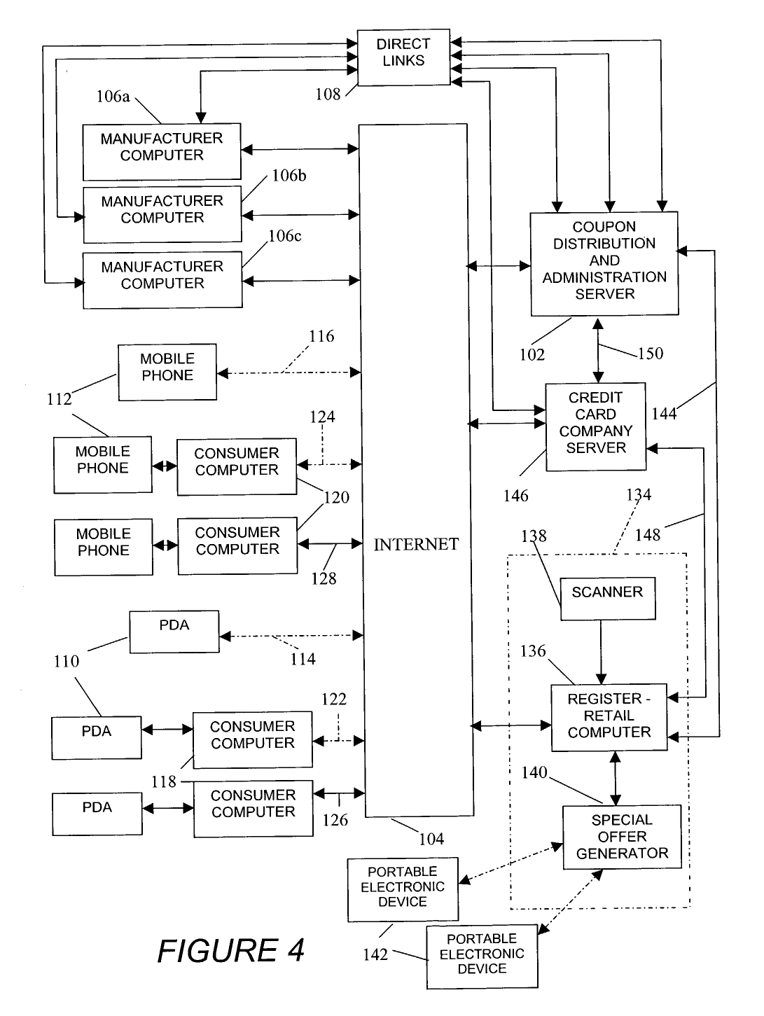

FIG. 4 depicts a central hub or coupon distribution system implemented via a coupon distribution and administration server 102 that is accessible via the Internet 104 by customers and consumers alike. One class of customers (subscribers to the coupon distribution system) consists of manufacturers or service providers whose computers 106a, 106b, 106c . . . may communicate with server 102 via the Internet 104 or via direct links 108.

All existing offers reside on a Web site maintained by coupon distribution and administration server 102. Server 102 categorizes the coupons and establishes coupon search procedures for use by consumers. Consumers may access server 102 directly via a portable electronic device such as a personal digital assistant (PDA) 110 or mobile telephone 112 and respective wireless links 114 and 116 to the Internet 104. Alternatively, consumers may search for and download electronic coupons by using personal computers 118, 120 connectable to server 102 via the Internet 104 and wireless connections 122, 124 or hard-wired communications links 126, 128. Consumers wishing to partake in offers made available by server 102 register for an account by providing information, such as their name, address, and buying preferences. Registered consumers are permitted to select a username and password, and are assigned a user number (transparently).

The coupon distribution system incorporates a first kind of couponing software utilizable on personal computers 118, 120 and another kind of software utilizable on portable electronic devices such as PDAs 110 and mobile telephones 112. This software may be made available for free download at the coupon distribution Web site maintained by server 102. The software may be downloaded and hot-synced to the portable electronic device. Once loaded, the software provides all required couponing features to users of portable electronic devices.

PDAs 110 and mobile phones 112 may download the applicable implementing software via the Internet 104 either directly via wireless links 114 and 116, or indirectly via the users' personal computers 118, 120. Alternatively, the implementing software for the various portable electronic devices may be loaded from a diskette or compact disk (CD) either directly or via the users' personal computers 118, 120. Other methods of software distribution will be apparent to those skilled in the art. For instance, where a television set is equipped with a set top box 130, download to a portable electronic device 132 may be achieved via the television box. The method is not central to the present invention.

As depicted in FIG. 4, a representative retail location 134 has at least one computer 136 connected to distribution and administration server 102 via the Internet 104 or, alternatively or additionally, via a dedicated link. One or more scanners 138 (e.g., laser scanners) are connected to retail computer 136, providing that computer with electronic coupon information collected by scanning the displays 12, 18 (FIGS. 1-3) of user-provided portable electronic devices. Retail location 134 may be equipped with a special offer generator 140 for creating and loading electronic coupons into users' portable electronic devices 142 on or near the premises of retail location 134. As discussed below, retail computer 136 is connected to coupon distribution and administration server 102 either directly via a line 144 or indirectly via the Internet 104 for purposes of performing checks on purported promotional offers proffered by consumers. In addition, retail computer 136 is linked to a credit card company server 146 either directly via a line 148 or indirectly via the Internet 104 for purposes of performing checks on consumer credit card accounts. In addition, credit card company server 146 may be connected to coupon distribution and administration server 102 directly via a line 150 for purposes of enabling an automatic check as to whether a consumer's tender of a promotional offer via electronic coupon is valid and authorized. Upon finding that a consumer has appropriate credit and an authorized promotional offer, computer 146 transmits a signal to retail computer 136 authorizing the transaction.

Consumer account registration and transparent user numbers provide several key benefits. Consumers can receive tailored offers, which saves them time searching and decreases the likelihood of their missing an offer they might have been interested in. The manufacturers reach individuals more readily and will be able to track the habits of specific individuals or groups if desired. With consumer account registration and transparent user numbers, coupon distribution and administration server 102 is able to track which individuals requested which specific offers and can provide reports to customers (manufacturers, retailers, service providers) filtered in any way desired by each customer. Additionally, customers can provide targeted special offers to individuals via e-mail if desired.

Customers sign up with the coupon distribution and administration company that operates server 102, to obtain a variety of services. In addition to publishing promotional offers, server 102 can automatically create the on-line offers, track the offers (by date, time, individual, etc.), track who is taking advantage of the offers, and provide monthly reports, middle-man billing of companies, and reimbursement to stores (if necessary).

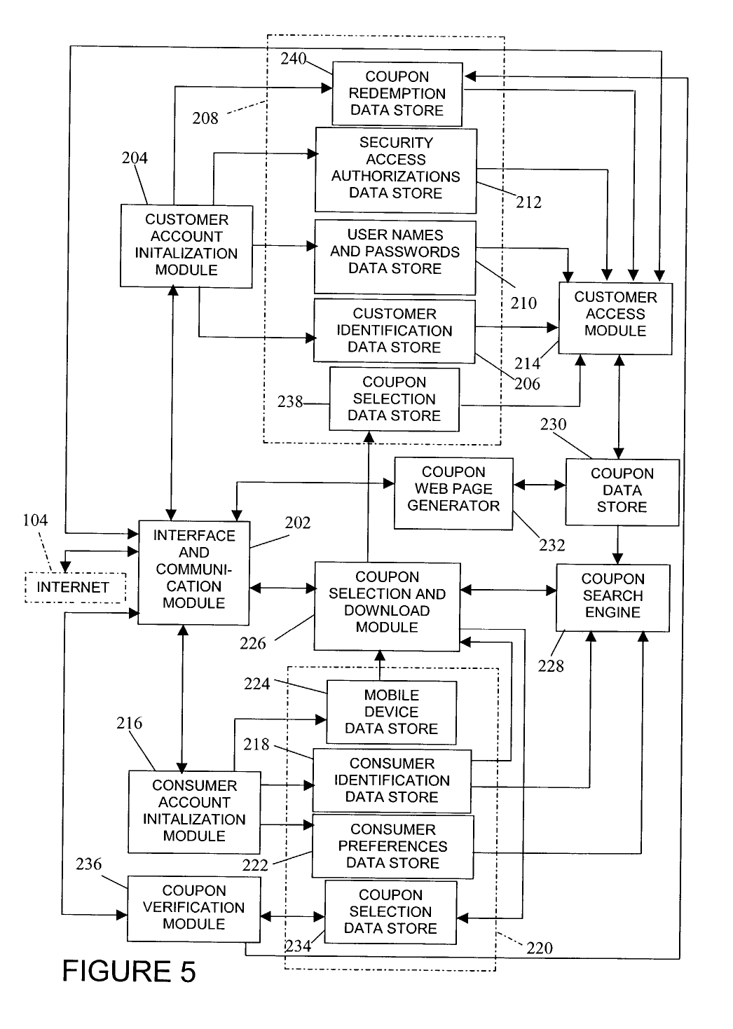

As illustrated in FIGS. 4 and 5, coupon distribution and administration server 102 includes an interface or communications module 202 linked to the Internet 104 as well as to any direct communications links 108 (including wireless channels). Module 202 is responsible for transmitting the various pages of the coupon distribution and administration Web site over the Internet 104 and for monitoring consumer and customer access to the various coupon services provided by server 102.

A customer account initialization module 204 is connected to interface and communication module 202 for setting up customer accounts. Module 204 is active whenever a new account is generated or modified by a customer. Of course, a customer may access and modify only his or her own information, and control is maintained by typical username/password access. It may be necessary to create security access levels if customers intend several individuals to be able to access the account with different authorizations. Changes must be confirmed before taking effect.

Customer account initialization module 204 stores in a first data store 206 of a server memory 208 such customer information such as the corporate name of the customer, an office address, and one or more telephone and cell phone numbers. In another data store 212 of memory 208, module 204 lodges a list of users, together with user names and passwords for each user. In another data store, 212 of memory 208, module 204 registers security access authorizations for each user. Thus, the individual users are authorized to have access only to selected parts of the corporate account of the respective customer.

As further illustrated in FIG. 5, coupon distribution and administration server 102 includes a customer access module 214 that permits registered customers to perform administrative functions relative to their active offers such as offer placement, editing, removal, tracking, report generation, and account billing and balances. To that end, access module 214 is connected to various data stores of memory 208 for enabling module 214 to first verify account information.

As additionally illustrated in FIG. 5, coupon distribution and administration server 102 includes a consumer account initialization module 216 connected to interface and communication module 202 for setting up consumer accounts. Module 216 is active whenever a new account is generated or modified by an individual user for purposes of downloading electronic coupons. Consumers may access and modify only their own accounts and control is maintained again by typical username/password access.

Consumer account initialization module 216 stores in a first data store 218 of a server memory 220 such consumer information such as the consumer's name, home address, email address, and a telephone or cell phone number. In another data store 222 of memory 220, module 216 enters consumer preference information such as desired savings categories, requested specials notifications, and requested email notifications. In a further data store 224 of memory 220, module 216 implements a mobile device registration for enabling a coupon selection and download module 226 to custom-format electronic coupons or promotional offers for consumers' portable devices.

Selection and download module 226 is connected to interface and communications module 202 for receiving consumer inquiries pertaining to promotional offers available via the coupon distribution and administration service. In response to such inquiries, module 226 activates a coupon search engine 228 to access a coupon data store 230. Coupon data store 230 contains all relevant data pertinent to available or outstanding (and optionally, future) promotional offers instituted by the service's customers via access module 214. Relevant data includes, but is not limited to, coupon title, relevant products or product lines, expiration date, and value. A consumer inquiry may result in a display of available promotional offers, as identified by the relevant data, on an Internet Web page. To that end, search engine 228 and/or coupon data store 230 is connected to a Web page generator 232, which is in turn coupled to interface or communications module 202. Search engine 228 is informed in its functions by consumer identification and preferences information from data stores 218 and 222. Pursuant to the pre-recorded preferences of the inquiring consumer, search engine 228 may search promotional offers or manufacturers of indicated interest to that consumer. Of course, the consumer may have the option of directing a search to other areas.

When coupon selection and download module 226 receives a request for a coupon download, the selected coupon is formatted according to the pertinent device identification information in data store 224. The properly formatted electronic coupon is then sent, for instance, by email to a consumer email address registered in data store 218 or directly to the consumer's computer 118, 120 for eventual download to their portable device 110, 112. Module 226 records the fact of the coupon selection and download, including the coupon identification, date, expiration, and value, in another data store 234 of memory 208. Retail computers 136 (FIG. 4) may perform a check on whether a consumer attempting to redeem an electronic coupon is authorized to redeem that coupon, by accessing a coupon verification module 236 connected on one side to interface or communications module 202 and on another side to coupon selection data store 234.

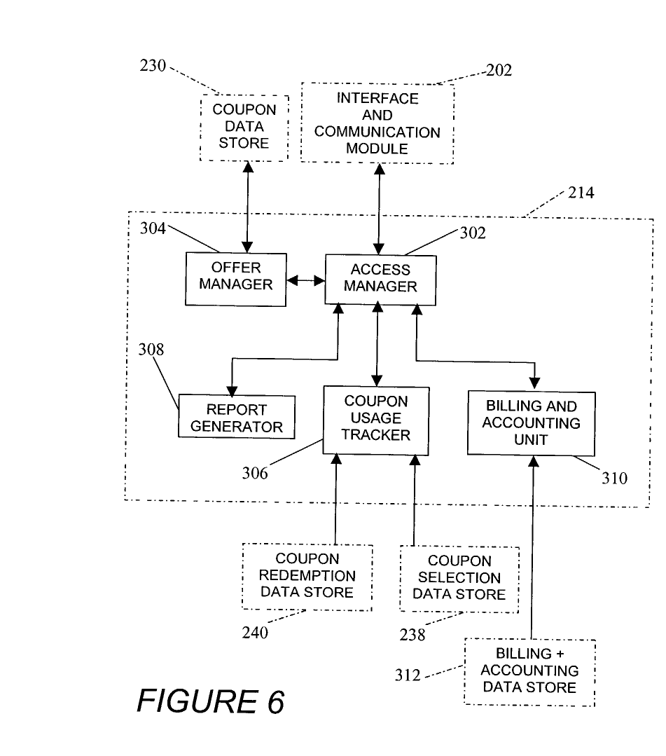

As shown in FIG. 6, module 214 includes an access manager 302 connected to interface or communications module 202 for receiving, from customer computers 106a, 106b, 106c, etc. (FIG. 4), requests and instructions for selecting functions or setting preferences, for viewing filtered reports on the respective customers' offers, for determining related demographics of those who have downloaded coupons or took advantage of the offers, for activating, modifying or deactivating an offer, and for setting dates and/or times for automatic activation and/or deactivation of selected promotional offers.

Customer access module 214 also includes an offer manager 304 (FIG. 6) connected to access manager 302 for accessing, under the control thereof, coupon data store 230 for purposes of creating, modifying, activating, deactivating, and setting times for automatic activation and/or deactivation, of customers' promotional offers. Customer access module 214 additionally includes a coupon usage tracker 306 linked to access manager 302 for selecting and setting customer preferences with respect to tracking functions and for implementing the tracking functions. To that end, coupon usage tracker 306 is connected to coupon data store 230 for tracking the outstanding or pending promotional offers, and to a coupon selection data store 238 for tracking the history and statistics of coupon selection. Data store 238 is updated by coupon selection and download module 226. Coupon usage tracker 306 may additionally be connected to a coupon redemption data store 240, which is a part of memory 208. Redemption data store 240 is connected to coupon verification module 236 for keeping records of the redemption rate and other statistics relevant to various promotional offers.

Customer access module 214 (FIGS. 5 and 6) includes a report generator 308 that cooperates with tracker 306 and redemption data store 240 to generate statistics on coupon download and usage. Report generator 308 may provide data in any of several formats in accordance with customer preferences. Common formats include graphs and charts filtered, for example, by offer, all offers at once, demographical information (e.g., geographical location), etc. Statistics may include the number of downloads, the number of redemptions, the number or percentage of unredeemed downloads, and possibly where the redemptions were by geographical location or store name.

Customer access module 214 may additionally incorporate a billing and accounting unit 310 which generates invoicing from information recorded in a billing and accounting data store 312 that may form a portion of memory 208.

Once the functions of customer access module 214 are selected, the user's security access level will be used to determine those functions the user may access or modify and will restrict access or changes to areas for which a user is not authorized.

In addition to automated access, customers can interact with an account manager of a coupon distribution and administration company. This company can be flexible to provide support to any or all of the phases including concept development, marketing research, development of on-line marketing materials, coupon/advertisement design, account maintenance and reporting, collections and billing, etc. Level of required service may typically determine monthly billing for services.

Server 102 includes modules (not shown) for downloading implementation software to PDAs 110, mobile or cellular phones 112, and computers 118, 120. The software contains all required functionalities to access, download and use electronic coupons and vouchers. The software contains two modules. One resides on the portable electronic device. The other resides on the host computer 118, 120 and mediates or controls relevant communications between the computer 118, 120 and the Internet 104, on the one hand, and between the computer and the portable electronic device 110, 112, on the other hand. As such, when coupon and offer information arrives from the Internet 104, it will be intercepted by the driver software on the host computer. A header on the downloaded information provides direction as to which portable device 110, 112, etc., it should be routed to and where and which application on the portable electronic device 110, 112 requires the information. The implementation software thus directs any promotional offers downloaded from the Internet into the hot-sync buffer for the selected portable electronic device 110, 112. The actual downloading of the information can be accomplished using the manufacturers' available PDA or phone interface software. The software on the portable electronic device 110, 112 may contain an encryption/decryption engine so that the data may not be used directly should it be somehow intercepted.

The implementation software residing on the portable electronic device 110, 112 will manage the consumer's ability to access and present coupons and other promotional offers to merchants. Functions of this implementation software include coupon searching, coupon organizing, coupon displaying, and coupon management. Delimiters may be used to narrow search for valid promotional offers. The consumer may organize offers (i.e., like in folders) to simplify access. As an example, shoppers can group their valid coupons prior to shopping to make access at the cash register simpler. Displaying the offers may require decryption prior to display. The offers are displayed for a specific period of time and are then wiped from the memory of the portable electronic device once tendered. General coupon management functions include deletion capabilities and checking the coupon expiration dates to auto-delete once they are invalid.

Logging onto the Web site maintained by interface and communications module 202 of server 102, consumers are able to browse the categories for current offers. An on-site caveat advises consumers that offers can expire at any time. (Customers will generally retain the right to terminate their respective promotional offers unilaterally at any time. This procedure, however, may help to encourage impulse buying.) Using the date and/or time function of the PDA 110 or mobile phone 112 or other portable electronic device, the implementation software resident in the device may remove expired coupons automatically so as to prevent presentation after offer termination.

Consumers' profiles are stored in preferences data store 222 and can be modified by the consumers as desired. Should coupon selection and download module 226 discover, pursuant to a stored profile, that an offer exists in a flagged area of interest, the consumer can click a button (on a Web page transmitted to the consumer's browser by interface and communication module 202) to receive information for each such existing offer. Once selected, the electronic coupon is downloaded via module 226 and placed into a hot-sync buffer for the consumer's portable electronic device, e.g., PDA 110 or phone 112. The next time the portable unit is hot-synced, the coupon or voucher is loaded into the portable electronic device. Any information required by law or desired by the customer is downloaded as text and associated with the coupon or voucher. Only a subset of the downloaded information, such as the discount value and promotion title will likely appear with the barcode 14 (FIGS. 1-3) due to screen resolution limitations.

The consumer brings their portable electronic device, e.g., PDA 110, mobile phone 112, etc., carrying the downloaded electronic coupon into a retail establishment 134 (FIG. 4) and uses the implementation software to display the offer on the display 12, 18 of their portable electronic device, at the cashier's register. The barcode 14 of the electronic coupon is scanned from the display 12, 18 of the portable electronic device 110, 112, etc., by the cashier and shows up on their register or retail computer 136 (FIG. 4) as a discount. The coupon then is securely wiped from the portable electronic device's screen and internal memory.

After the scanning of the displayed barcode 14 and the entry of the tendered promotional offer into the register or computer 136 at the retail location, several alternative approaches may be taken. First, if no tracking is required or desired, the discount may be provided to the consumer and the sale concluded, though no audit trail would exist. Second, the electronic coupon might carry a user identification number assigned to the particular user by consumer account initialization module 216 and incorporated into the electronic coupon by selection and download module 226. In this scenario, the consumer may show the clerk an identification card. The clerk compares the consumer identification number on the display 12, 18 of the consumer's PDA 110 or mobile phone 112, etc., with the identification number on the card to ensure that the two numbers match before permitting the discount.

If desired by the store, the consumer identification card can have a separate identifying barcode, which could be scanned as well. The retail computer 136 (FIG. 4) can access and upload this information to server 102 for storage and report generation, to determine the percentages and demographics associated with persons taking advantage of the offer(s). This tracking is accomplished by coupon verification module 236 (FIG. 5), with the tracking results being recorded in data store 240. The redemption records are accessed by the respective customers via access module 214 and more particularly by coupon usage tracker 306 (FIG. 6).

It is possible for the coupon distribution and administration company operating server 102 to build a business relationship with credit card companies such as Visa and Mastercard or clearing houses such as First Data. In this third scenario or approach, once a sale is tallied, the discount barcode 14 could be tagged as a discount when it is scanned into the register or retail computer 136. The consumer presents a credit card to the cashier, who swipes the card through a card reader in the conventional fashion. The sale total and the electronic coupon discount amounts are forwarded to the credit card company's processing computer 146 (FIG. 4) via direct line 148 or the Internet 104. The credit card company has identity information for the consumer, including, for instance, the consumer identification code assigned by account initialization module 216 (FIG. 5) and recorded in data store 218. This identification number is used by the credit card processing computer 146 to access the consumer account on server 102 (via coupon verification module 236) to ensure the consumer actually downloaded the coupon for the product purchased. If verified, the consumer receives the discount on their register receipt and ultimately their credit card bill.

This method of coupon verification closes the loop to ensure that discounts are only credited to persons purchasing the product. It also ensures that a coupon may only be used once, if this is a restriction. Additionally, if the product is later returned, it will typically need to be credited by the retail store to the same credit card. Once again, their link to server 102 of the coupon distribution and administration service will ensure that the discount is deducted from the refund price. This is especially important if the discount is acting as an instant rebate (i.e. for an electronic equipment purchase).

In another scenario or approach to coupon redemption, portable electronic devices are equipped with low-cost scanners (not shown). After a coupon is redeemed, the portable electronic device is operated to scan a barcode identifying the store at which the respective discount was redeemed. The next time the consumer hot syncs at home, information regarding the customer number, purchase, discount used and store at which it was redeemed may be uploaded to the server 102. This provides further validation and demographic information for customers of the coupon distribution and administration service.

In another variation of the methods described herein, stores may be equipped with ‘beam’ units or hard-wired transmission links for enabling information exchange between the store's register or computer 136 (FIG. 4) and the consumer's portable electronic device 110, 112, 142. Exchanged information could include validation and purchase information, and could be used to send the coupon or voucher to the register or retail computer 136.

Internet Download from Manufacturer's Site

A scenario in which electronic coupons are downloaded from manufacturers' Web sites works basically as described above, with differences noted as follows.

Manufacturers are still members or customers of the coupon distribution and administration service and still access their accounts on server 102. The manufacturers' Internet sites advertise the respective manufacturer discounts and explain that to claim the discounts, consumers need to be registered with the coupon distribution and administration service. For non-member consumers, the manufacturer Web sites explain that membership is free and forwards interested consumers to a sign-up page generated by interface and communication module 202 in cooperation with consumer account initialization module 216. For members or registered consumers, clicking on a discount either automatically or manually permits the member to log on. After log-on, the member is transferred to a Web page containing the selected discount.

By routing all advertisements to the Web site maintained by server 102, that server can track who the member is, which site forwarded them, and what discounts they have downloaded.

Internet Download from Store's Web Site

This scenario works the same as described above in the “Internet Download from Manufacturer's Site” section, except the consumer is forwarded to the server 102 from the retail store's Web site.

Received from Store at Register

Under this scenario, the retail store transfers a coupon or voucher to the consumer's portable electronic device 110, 112, 142 at the register. For this scenario to work, the register or retail computer 136 must contain or be connected to a small device (not shown) with a wireless (e.g., IR) link in order to wirelessly transmit the coupon or voucher to the portable electronic device.

Broadcast from In-store Terminal (e.g. Blue Light Specials, Sweepstakes, etc.)

While consumers are shopping in a store, special bargains are somehow disclosed or announced to the consumers. Within the store is disposed one or more bargain terminals equipped with or connected to special offer generator 140 (FIG. 4). These terminals broadcast the coupons constructed by generator 140 to portable electronic devices 142 that are loaded with the coupon implementation software. If desired, portable devices 142 can disclose the consumers' identification numbers (created or selected via initialization module 216) to the terminal. Once loaded into the portable electronic devices 142, the coupons or vouchers can be redeemed in any manner described in this document.

As an added shopping incentive, the specials may be tagged with a time limit. For example, the consumer might have twenty minutes to redeem a coupon, or may use it that same day only.

Instant sweepstakes may also emanate from this terminal. Lucky consumers may win discounts, vouchers, or some other prize.

Broadcast Over the Air to Wireless Phone

Where the portable electronic device is mobile phone 112 or other device that contains an RF link, consumers may be provided with electronic coupons or promotional offers via a general broadcast to the device.

The coupon distribution and administration company may establish a relationship with the major mobile phone companies, whereby coupon distribution and administration is provided as a telephone service, either free or for a minimal monthly charge. As an enticement, a mobile phone company could guarantee that it will not assess a monthly charge if the total of the coupons redeemed are less than the monthly fee.

Consumers may search for coupons or vouchers by using a menu on the mobile phone 112. Once found, a promotional offer such as a discount may be selected and the respective electronic coupon downloaded into the phone 112. The mobile phone 112 contains the appropriate implementation software. When purchasing a product, a user or consumer permits the phone's display 18 to be scanned, as described above. If desired, once the coupon is redeemed, the phone can connect to server 102 to detail the sale and discount, and to update the database.

Consumers may also access their accounts and coupons for downloading from the Internet 104. If a user's phone supports connection to a PC, data can be downloaded directly. Otherwise, by indicating the mobile phone's number in the consumer's personal profile, server 102 may call and download the offer directly to the phone.

Broadcast Over the Air via Bluetooth™ Network

This method is the same as described above for “Broadcast over the Air to Wireless Phone”, except that a wireless network is used instead. Bluetooth™ is such a network currently growing in popularity and supported by many portable electronic devices.

In this scenario, network-enabled phones or PDAs may accept coupons or vouchers for redemption. Additionally, the network can link back to server 102 in order to record coupon redemption and pertinent consumer and sale information.

Advantages

Corporate customers have direct access to respective accounts maintained by server 102 to initiate an offer, rescind it, access tracking information or consumer demographics, or request specific reports. The access is had via a coupon distribution and administration Web site maintained by interface and communication module 202 and access module 214.

Electronic coupons can be instantly removed from offer. Paper coupons, once printed, continue to proliferate and trickle in to retail establishments until (and sometimes after) the printed expiration date. To void a coupon offer, customers can either request server 102 to stop offering it, can manually remove the offer from within their account, or can attach a removal time/date to the offer so this happens automatically at a predetermined time.

Customers can potentially track specific consumers and a world of demographic information. Money can be saved by reducing or eliminating the necessity for coupon designers, printers and distributors. Money can also be saved by eliminating the need for coupon clearing houses. The tasks performed when tracking paper coupons are manual and time intensive.

The electronic coupon distribution and administration system comes with built-in security: Discounts are not given unless member numbers are verified, the offers are verified and/or links to server 102 verifies that the coupons were indeed requested by the users who purchased the respective products.

Software can track expiration dates of coupons or vouchers and automatically remove them when they are no longer valid. This process eliminates the issue sometimes seen with paper coupons, in which coupons are permitted to be redeemed past the expiration date due to cashier error.

Although the present invention has been described with reference to one specific preferred embodiment, the inventors' intent is to include in the present invention, all other descriptions detailed in the other sections of this document. Further, workers skilled in the art will recognize that changes may be made in form and detail without departing from the spirit and scope of the invention.

What is claimed is:

1. A method for information transfer, comprising:
loading data into a portable electronic device having a display;
displaying at least a portion of said data in a predetermined format on said display; and
presenting said display to a scanner to enable a scanning of said portion of said data on said display.

2. The method defined in claim 1 wherein said predetermined format includes a bar code.

3. The method defined in claim 1 wherein the presenting of said display to a scanner is performed at a retail outlet, said portion of said data encoding a promotional offer pertinent to a predetermined product purchased at said retail outlet.

4. The method defined in claim 1 wherein said portable electronic device is taken from the group consisting of mobile telephones, cellular telephones, personal digital assistants, pagers, electronic gaming devices, portable television sets.

5. The method defined in claim 1 wherein the loading of said data into said portable electronic device includes transmitting said data to said portable electronic device.

6. The method defined in claim 1 wherein the loading of said data into said portable electronic device includes downloading said data at least indirectly from a World Wide Web site.

7. The method defined in claim 1 wherein the loading of said data into said portable electronic device includes transmitting said data from a source in a retail location.

8. The method defined in claim 1 wherein the loading of said data into said portable electronic device includes providing personal information to a provider of said data, in return for receiving said data.

9. The method defined in claim 1, further comprising automatically deleting at least a part of said data from said portable electronic device after the scanning of said portion of said data.

10. The method defined in claim 1, further comprising loading software into said portable electronic device prior to the loading of said data, and operating said portable electronic device pursuant to the loaded software to receive said data and display said portion of said data.

11. The method defined in claim 1, further comprising:
scanning said display to read said portion of said data therefrom; and
transmitting said portion of said data to an electronic accounting device.

12. A transactional method comprising:
receiving an electronic coupon comprising information in a predetermined encoded format;
storing said electronic coupon in a portable electronic device;
transporting said portable electronic device to a retail location; and
communicating at least a portion of said information from said portable electronic device at said retail location to permit execution of a promotional transaction at said retail location.

13. The method defined in claim 12 wherein the communicating of said portion of said information includes transferring said portion of said information to an electronic accounting device at said retail location.

14. The method defined in claim 13 wherein the transferring of said portion of said information includes displaying said portion of said information on a display of said portable electronic device at said retail location, thereby enabling a scanning of said display to transfer said portion of said information to said electronic accounting device.

15. The method defined in claim 13 wherein the transferring of said portion of said information includes transmitting said portion of said information over a communications link to said electronic accounting device.

16. The method defined in claim 12 wherein the receiving of said electronic coupon includes downloading said electronic coupon from a World Wide Web site.

17. The method defined in claim 12 wherein said electronic coupon is received from a coupon provider, further comprising supplying personal information to said coupon provider prior to the receiving of said electronic coupon.

18. The method defined in claim 12 wherein the receiving of said electronic coupon includes downloading said electronic coupon from a source at said retail location.

19. The method defined in claim 12, further comprising automatically deleting at least a portion of said electronic coupon from said portable electronic device after the communicating of said portion of said information at said retail location.

20. The method defined in claim 12, further comprising purchasing a product at said retail location, said electronic coupon being directed to the purchase of saidproduct, said promotional transaction including an adjustment in a purchase price of said product.

21. A method for facilitating promotional offers on the sale of consumer products, comprising:
receiving personal information from consumers; and
in response to the receipt of the personal information, automatically transmitting electronic coupons or vouchers to respective consumers.

22. The method defined in claim 21 wherein the receiving of said personal information includes receiving incoming signals via a global computer network, the transmitting of said electronic coupons or vouchers including transmitting outgoing signals via said global computer network.

23. The method defined in claim 22, further comprising maintaining a database of electronic coupon and voucher data and communicating at least a portion of that information via a World Wide Web site.

24. The method defined in claim 23, further comprising maintaining a database of consumer preference information; and organizing said information for statistical evaluation.

25. The method defined in claim 21 wherein said electronic coupons or vouchers include information that can be encoded in bar codes.

26. The method defined in claim 21, further comprising, prior to the transmitting of said electronic coupons or vouchers to said respective consumers, transmitting to said respective consumers software for enabling a communication of at least selected portions of said coupons or vouchers.

27. The method defined in claim 26 wherein said software includes means for enabling display of a bar code on a display of a portable electronic device.

28. The method defined in claim 21, further comprising:
receiving a query re a pending promotional transaction;
checking said personal information to verify validity of said pending promotional transaction; and
transmitting a signal authorizing completion of said pending promotional transaction.

29. The method defined in claim 21, further comprising generating said electronic coupons or vouchers in response to requests from corporate sponsors.

30. The method defined in claim 21, further comprising receiving coupon transmission requests from consumers, the transmitting of said electronic coupons or vouchers being carried out in response to said coupon transmission requests, further comprising automatically tracking coupon transmission requests.

31. The method defined in claim 21, further comprising:
receiving a termination request from a corporate sponsor; and
automatically terminating at least one of said electronic coupons or vouchers pursuant to said request.

32. A transactional method comprising:
scanning a display of a portable electronic device to collect information shown on said display;
entering the collected information to another electronic device; and
operating said another electronic device to extract the collected information and incorporate the extracted information in a transactional process.

33. The method defined in claim 32 wherein the scanning of said display includes operating a scanner instrument and the entering of said collected information includes automatically transmitting said collected information from said scanner instrument to said another electronic device.

34. The method defined in claim 33 wherein the scanning of said display includes operating a scanner.

35. The method defined in claim 32 wherein said collected information pertains to a promotional offer on a product for sale in a retail establishment, said transactional process being a sale of said product, the incorporation of said extracted information including accounting for a price adjustment in the sale of said product.

36. The method defined in claim 32 wherein the scanning of said display is done visually and the entering of said collected information is done manually.

37. The method defined in claim 32, further comprising:
generating a validation request signal in response to said extracted information;
transmitting said signal to a remote location;
receiving an authorization signal from said remote locations in response to said validation request signal; and
completing said transactional process upon receipt of said authorization signal.

38. The method defined in claim 32, further comprising transmitting an electronic coupon or voucher to said portable electronic device prior to the scanning of said display; the information on said display being at least a portion of said electronic coupon or voucher.
